(19) United States
(12) Patent Application Publication
(10) Pub. No.: US 2006/0285311 A1
(43) Pub. Date: Dec. 21, 2006

(54) Light-emitting device, backlight module, and liquid crystal display using the same

(76) Inventors: Chih-Li Chang, Tai-Nan City (TW); Chi-Jen Huang, Tai-Chung City (TW); Hung-Chen Kao, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,323

(22) Filed: Jun. 19, 2005

(51) Int. Cl. G09F 13/04

(52) U.S. Cl. 362/97; 362/240; 362/244; 362/246; 362/27

(57) ABSTRACT

A light-emitting device comprises at least one light source to emit a light and a transparent cap positioned over the light source. The transparent cap has a tapered interior for receiving and refracting the light from the light source and an exterior for refracting the light. The distance of light mixing is shortened conveniently using the light-emitting device.

### BACKGROUND OF THE INVENTION

1. Field of the Invention

The present invention relates to a light-emitting device, and more particularly to a light-emitting device that may be used in a backlight module for a display device.

2. Description of the Prior Art

An LCD device requires a light source because liquid crystal is not a fluorescent material. A cold cathode fluorescent lamp (CCFL) or the like has been included in a backlight module of the LCD device and used as the light source. However, the CCFL contains mercury (Hg), which is an environmental pollutant. It is therefore desirable to replace the CCFL with a light-emitting diode (LED).

Please refer to FIG. 1. FIG. 1 illustrates a structure of a conventional LED direct type backlight module 10. The LED direct type backlight module 10 includes a back-up structure 12, a printed circuit board 14, which includes a plurality of LEDs 16 situated in the back-up structure 12, a front frame 18 disposed on the back-up structure 12, a diffuser plate 20 installed on the front frame 18 for scattering the light from the LEDs 16, and optical films 22 installed on the front frame 18 to cover the diffuser plate 20.

FIG. 2 illustrates a general structure of the LED 16. The LED 16 is generally an LED package having a hemispherical lens 24 of a type well-known in the art. The LEDs 16 are disposed on the printed circuit board 14 and use a surface of the printed circuit board 14 as a reflecting surface. Since commercialized white light LEDs do not emit white light as saturated as desired, white light produced from a mixing of red, green, and blue light is preferred. However, for good mixing of red, green, and blue light, the LED direct type backlight module 10 using, for example, Lambertian RGB LEDs, must have an increased thickness.

Side-emitting LEDs have been proposed to emit light in a side direction, to resolve the thickness problem. FIG. 3 illustrates a cross-sectional view of a lens cap mated to an LED package. A lens cap 162 mates to a conventional LED package 16 having a hemispherical lens 24. Lens cap 162 is attached to the lens 24. Lens cap 162 includes a funnel shaped portion 58 having a reflecting (e.g., totally internally reflecting) surface I and a refracting surface H, as well as a lower portion 154 having a refracting surface 156 extending as a smooth curve from refracting surface H to a bottom surface 158. Light emitted by LED package 10 is directed by surfaces 1, H, and 156 of the lens cap 162 in a direction substantially perpendicular to a central axis 143 of the lens cap. When the side-emitting LEDs are used, a specific light guide is needed for directing the light to the desired position.

Due to using LEDs as a light source in the backlight module being the trend to avoid Hg contamination from a CCFL, the development for a novel light-emitting device is still needed to fabricate LCD devices having a relatively small thickness.

### SUMMARY OF THE INVENTION

It is an objective of the claimed invention to provide a light-emitting device, which may cause a refraction of the light from the originally used conventional LED package for condensing color and light mixing space, thus the thickness of a backlight module is reduced and the light mixing efficiency is improved.

The light-emitting device according to the claimed invention comprises at least one light source to emit a light and a transparent cap positioned over the light source. The transparent cap has a tapered interior for receiving and refracting the light from the light source and an exterior for refracting the light.

It is an advantage of the claimed invention that a conventional LED package can be suitably directly used in the light-emitting device together with the transparent cap to result in a shortened distance for light mixing. Accordingly, the thickness of the backlight module is reduced, and mixing efficiency of the light and the uniformity of luminance is improved.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a structure of a conventional LED direct type backlight module.

FIG. 2 illustrates a general structure of a conventional LED package.

FIG. 3 illustrates a cross-sectional view of a lens cap mated to an LED package in a prior art.

FIG. 4 illustrates a light-emitting device according to the present invention.

FIG. 5 illustrates a light-emitting device in another embodiment according to the present invention.

FIG. 6 illustrates an exploded view of the light-emitting device shown in FIG. 4.

FIGS. 7 and 8 show some examples of the cross-sectional views of the transparent caps with various shapes according to the present invention.

FIGS. 9 and 10 illustrate light paths for two examples of the transparent cap according to the present invention.

FIG. 11 is a graph showing the distribution of the luminance of light from the light-emitting device according to the present invention as shown in FIG. 4 and the distribution of the luminance of light from the conventional LED package.

FIG. 12 illustrates a direct type backlight module using the light-emitting device according to the present invention.

FIG. 13 illustrates a magnified view for part of the light-emitting device as shown in FIG. 12.

FIG. 14 illustrates a magnified view for part of the light-emitting device in another embodiment according to the present invention.

FIG. 15 illustrates a magnified view for part of the light-emitting device in still another embodiment according to the present invention.

FIG. 16 illustrates a graph showing the distributions of the luminance of light from an LED direct type backlight module using the light-emitting device according to the present invention as shown in FIG. 12 and from the conventional LED direct type backlight module as shown in FIG. 1

FIGS. 17 and 18 show the display screen for the LED direct type backlight module using the light-emitting device according to the present invention and for the conventional LED direct type backlight module.

### DETAILED DESCRIPTION

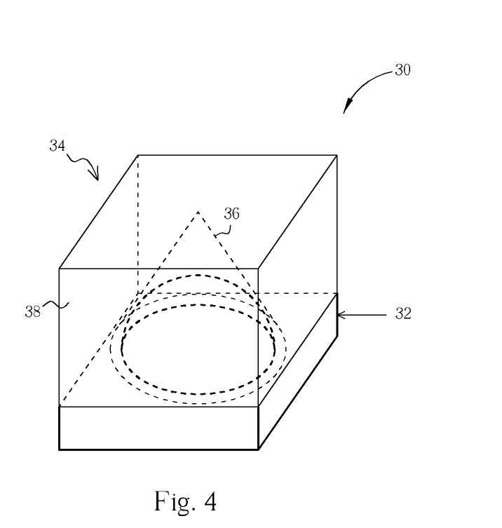

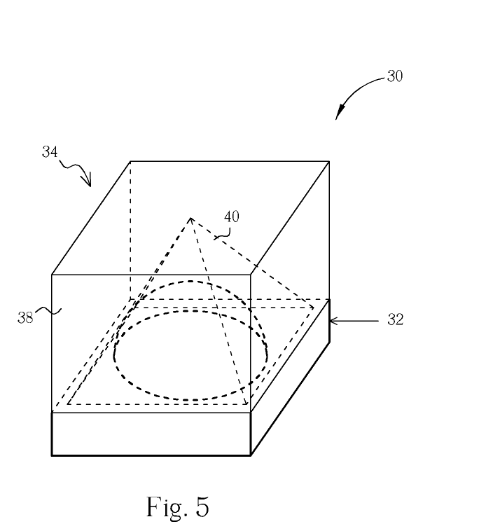

Please refer to FIGS. 4 and 5. FIG. 4 and FIG. 5 illustrate a light-emitting device 30 according to the present invention. The light-emitting device comprises an LED package 32 as a light source to emit a light and a transparent cap 34 positioned over the light source. The transparent cap 34 has a tapered interior such as a shape of cone 36 or pyramid 40 for receiving and refracting the light from the light source and an exterior 38 for refracting the light.

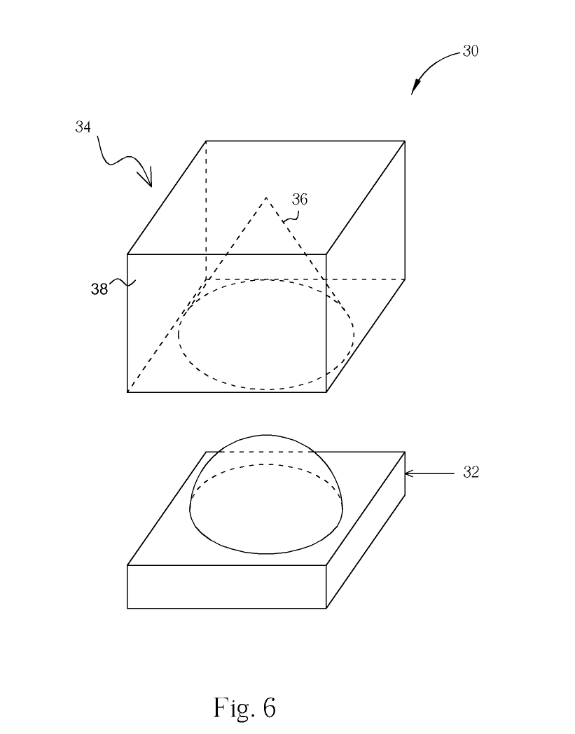

Furthermore, FIG. 6 illustrates an exploded view of the light-emitting device 30 in FIG. 4. The light-emitting device 30 comprises an LED package 32 as a light source to emit a light and a transparent cap 34 positioned over the LED package 32. The transparent cap 34 has a cone-shaped interior 36 for receiving and refracting the light from the LED package 32 and an exterior 38 for refracting the light. Accordingly, the light is refracted by the transparent cap 34 and transmitted at an angle with respect to the original light path from the LED package 32.

Take FIG. 6 to illustrate a light-emitting device as shown in FIG. 5. The transparent cap 34 has a pyramid-shaped interior 40 for receiving and refracting the light from the LED package 32 and an exterior 38 for refracting the light at an angle with respect to the original light path from the LED package 32.

Compared to the conventional LED package, in the light-emitting device according to the present invention, the light is emitted from a light source and refracted by an angle via the transparent cap such that the light can be advantageously mixed with the lights refracted in the same way from adjacent light sources at a relatively short distance. In turn, the thickness of the display device can be reduced and the light mixing uniformity can be retained or improved.

In order to attain the desired refraction, the shape of the tapered interior or the exterior of the transparent cap may be varied, as long as the light emitted can be changed to a direction at an angle with respect to the longitudinal axis of the light source for performing light mixing. The shape of the tapered interior may be, for example, but not limited to, a conical shape, ridge shape, a pyramid shape, and the like. The conical shape may have a pointed (or an angular) tip or arc tip and an inclined surface as a funnel shape. The inclined surface of the conical shape may be flat or curved or further have one or more bends. The ridge shape may have an angular corner or arc-shaped corner and two inclined surfaces to form the corner. The inclined surface of the ridge shape may be flat or curved or further have one or more bends. The pyramid shape may have an angular vertex or arc-shaped vertex and a number of inclined surfaces. Each inclined surface of the pyramid shape may be flat or curved or further have one or more bends. The pyramid shape may have a base in a shape of polygon, such as triangle, quadrangle, rectangle, square, pentagon, and the like. The tapered angle of the tip or corner is preferably less than 135 degrees, and more preferably in a range of about 45 degrees to about 80 degrees.

The transparent cap of the present invention may be made of transparent material, such as cyclic olefin copolymers (COC), polymethylmethacrolate (PMMA), polycarbonate (PC), PC/PMMA, silicones, fluorocarbon polymers, and polyetherimide (PEI), preferably with a refraction index of about 1.3 to 1.8, and more preferably about 1.4. The transparent cap 34 may be manufactured as a separate member using a number of well-known techniques such as diamond turning, injection molding, and casting. When the transparent cap is applied in the light-emitting device of the present invention, it may be put directly on the LED package base to be over the light source by various adhesion techniques.

The exterior of the transparent cap may have a flat top and a side wall, a multi-faceted top having a flat and a side wall, or may be in an arch shape.

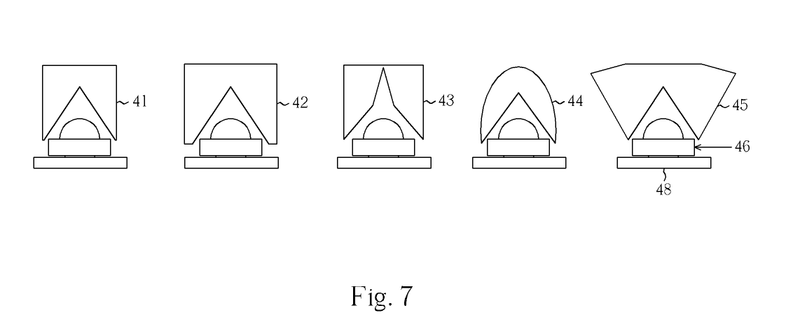

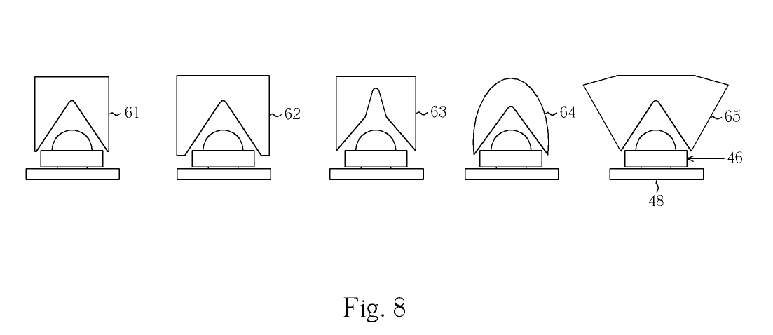

FIGS. 7 and 8 show some examples of the cross sectional views of the transparent caps with various shapes, as mentioned in the above description, and each transparent cap is positioned over an LED 46 on a base sheet 48. The transparent cap 41 could be a tapered interior and an exterior having a flat top, straight side walls, and an angular bottom. The transparent cap 42 could be a tapered interior and an exterior having a flat top, straight sidewalls, and a flat bottom. The transparent cap 43 could be a tapered interior with a bend on the inclined surface and an exterior having a flat top, straight side walls, and an angular bottom. The transparent cap 44 could be a tapered interior and an exterior having an arc shape and an angular bottom. The transparent cap 45 could be a tapered interior and an exterior having a multi-faceted top and a side wall inclining inward and downward from the top and an angular bottom. Furthermore, lead an arc-shaped tip into transparent caps 61, 62, 63, 64, and 65 according our invention as shown as FIG. 8.

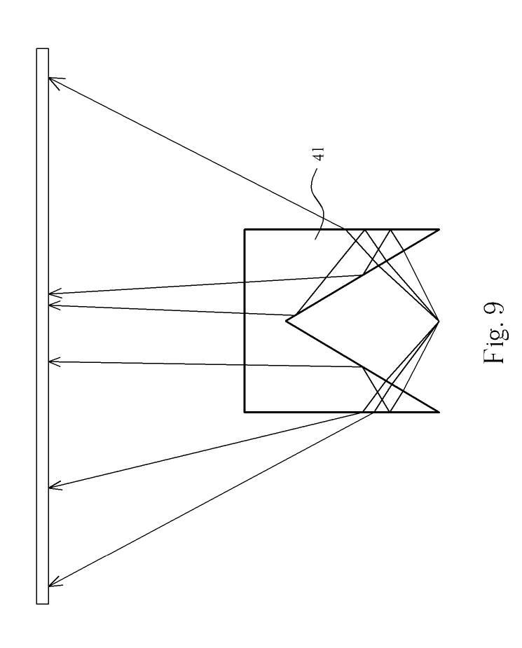

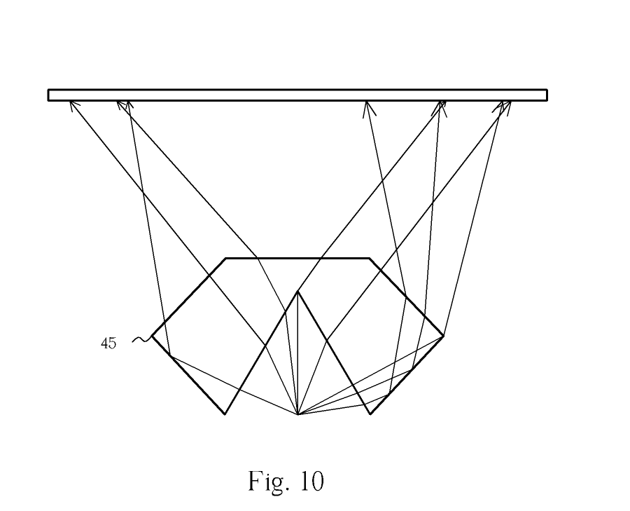

FIGS. 9 and 10 illustrate light paths for two examples of the transparent caps 41 and 45 according to the present invention. It is clearly shown that the transparent caps refract light beams received by the tapered inner surface. The transparent cap 41 shown in FIG. 9 has a good efficiency because the transparent cap 41 has an exterior in a rectangular parallelepiped or cubic shape. Parts of the light beams received by the interior is refracted and emitted through the side walls into an ambiance. Parts of the light beams received by the interior is reflected by the side wall and then emitted and refracted through the top into an ambiance. The transparent cap 45 shown in FIG. 10 also has a preferred efficiency because the transparent cap 45 has an exterior having a multi-faceted top and a side wall inclining inward and downward from the top, such that part of the light received by the interior is reflected by the side wall and then emitted and refracted through the multi-faceted top into an ambiance. The resulting light direction will enhance excellent color mixing and the distance for color mixing can be much reduced.

The light source used in the present invention may be a point light source or a linear light source, such as an LED package, a row of LED packages, and a CCFL. Other types of light sources also can be used.

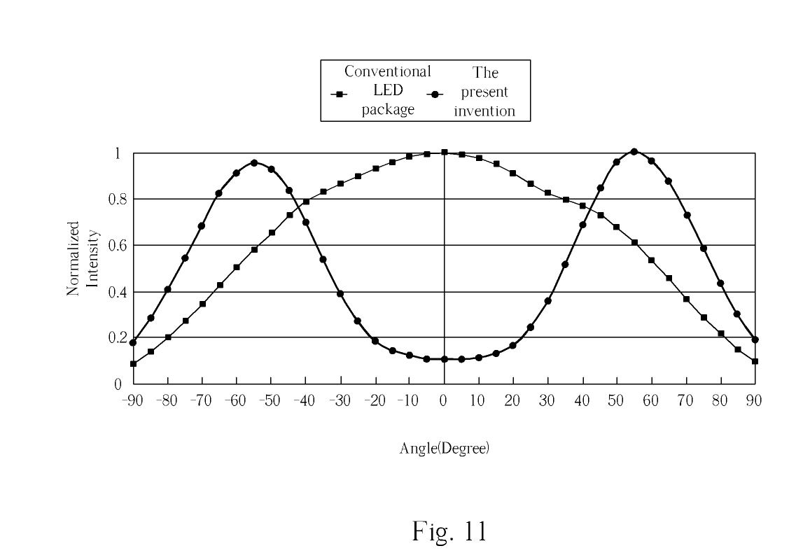

FIG. 11 is a graph showing the distributions of the luminance of light from the light-emitting device 30 according to the present invention as shown in FIG. 4 and from the conventional LED package 32 only. As shown in FIG. 11, the luminance of light is measured at angles with respect to a longitudinal axis of the light source. The light emitted from the LED package exhibits the highest intensity at the central area and then the intensity decreases as the angle increase. The light emitted from the light-emitting device 30 is refracted by the transparent cap 34 and exhibits a highest intensity at an angle of 50 to 60 degrees from the longitudinal axis and then the intensity decreases as the angle increases and decreases. Therefore, when a plurality of light-emitting devices according to the present invention are used in a display device as a back light using a light mixing technology, the light mixing distance can be shortened, as compared with the back light using the conventional LED packages only.

The transparent cap of the present invention can be positioned as a singular component over the light source, as shown in FIGS. 4 and 5. In the alternative, a plurality of light sources and transparent caps can be used in a backlight module as a panel light source device.

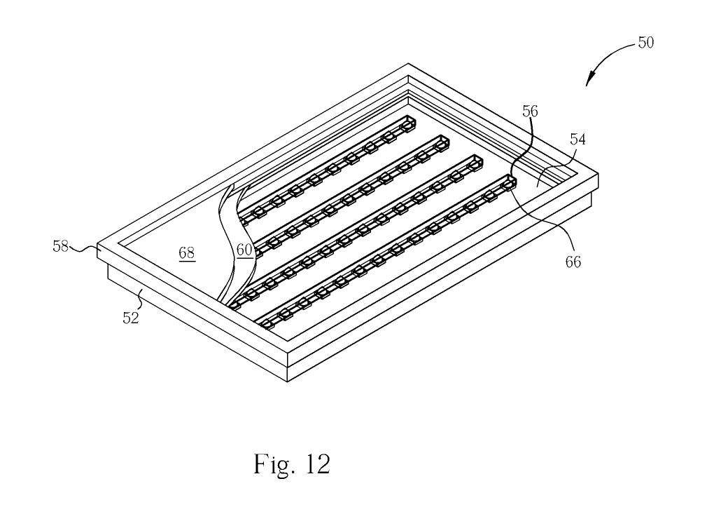

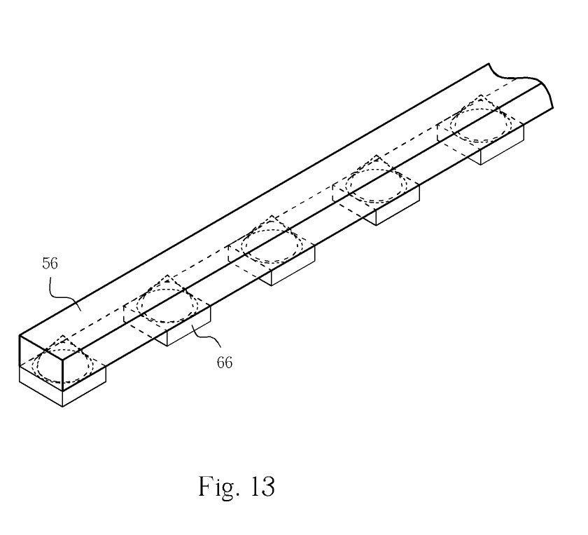

As shown in the FIG. 12, a direct type backlight module 50 comprises a back-up structure 52, a printed circuit board 54, which includes a plurality of LED packages 66 comprising red, green, and blue LED packages as light sources arranged in lines, situated in the back-up structure 52, a plurality of transparent caps 56 respectively positioned on the LED packages 66, a front frame 58 disposed on the back-up structure 52, a diffuser plate 60 installed on the front frame 58 for scattering the light from the LED packages 66, an optical film 68 installed on the front frame 58 to cover the diffuser plate 60. In this embodiment, also referring to FIG. 13 showing a magnified view for part of the light-emitting device, the transparent caps 56 are in a bar shape while have a plurality of conical interiors each accommodating the LED package 66 for light receiving and refraction.

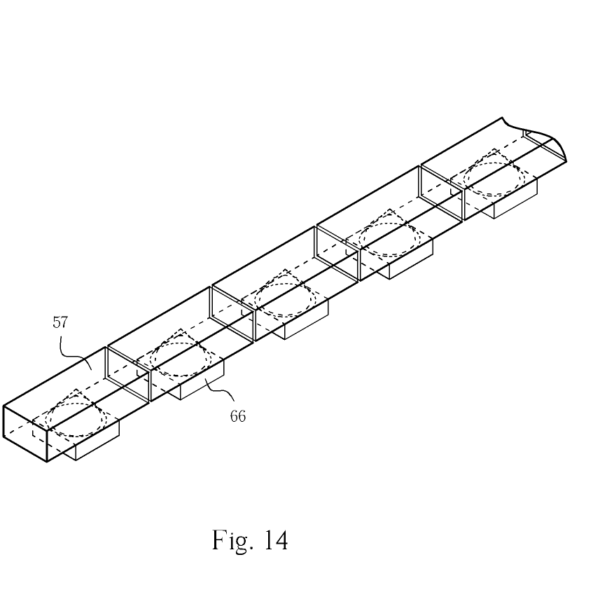

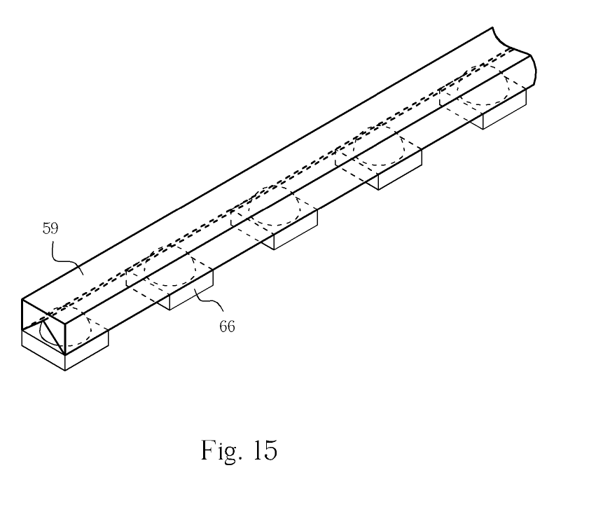

In another embodiment, the bar-shaped transparent caps may be formed by connection of a plurality of individual transparent caps, as shown in FIG. 14. In still another embodiment, referring to FIG. 15, the transparent cap 59 may be in a bar shape with an interior in a ridge shape along the whole bar-shaped transparent cap.

In still another embodiment the transparent cap may be in a plate shape (not shown) with a plurality of tapered interiors each over a light source for receiving and refracting the light.

The resulting backlight module may have a thickness depending on the size of LED package used, typically of 40 to 60 mm from the printed circuit board to the diffuser plate, thinner than that of the conventional LED direct type backlight module only using the LED packages as light sources. The backlight module may not include a diffuser plate in case that the light emitting-device according to the present invention has already attained a uniform light emitting.

The light-emitting device according to the present invention can be used in a side-edge backlight module as well as in a direct type backlight module. The distance of light mixing can be also shortened, and thus the size of the side-edge backlight module can be reduced.

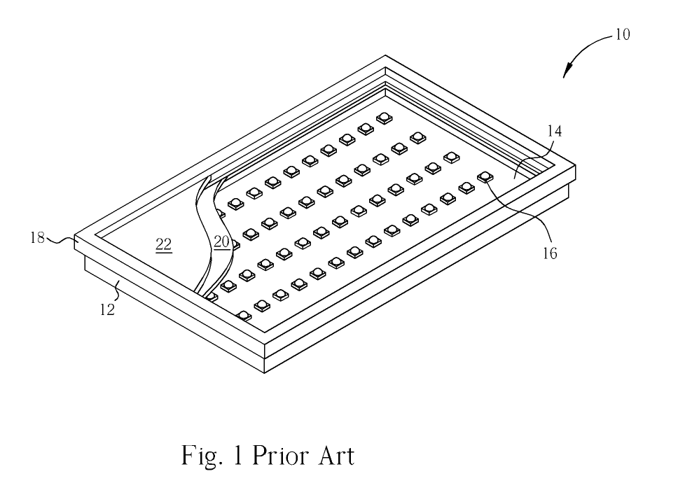

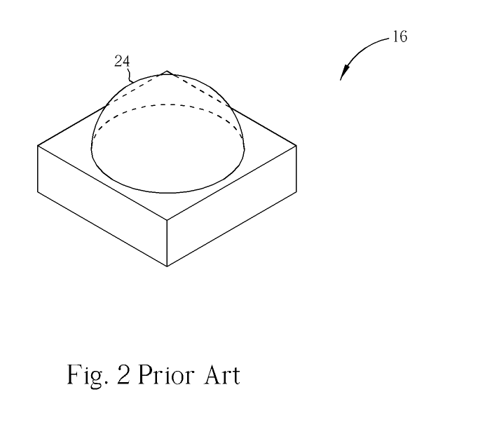

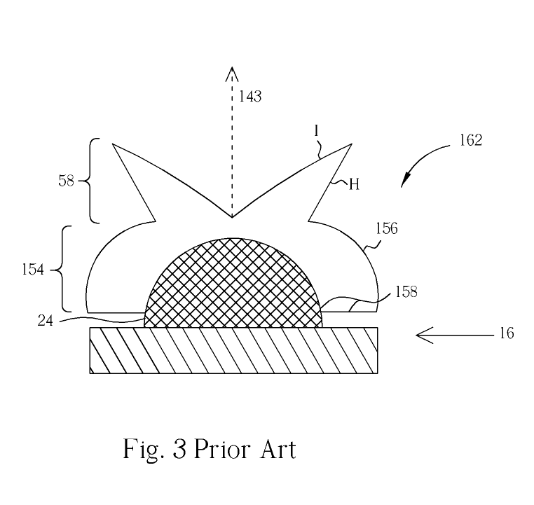

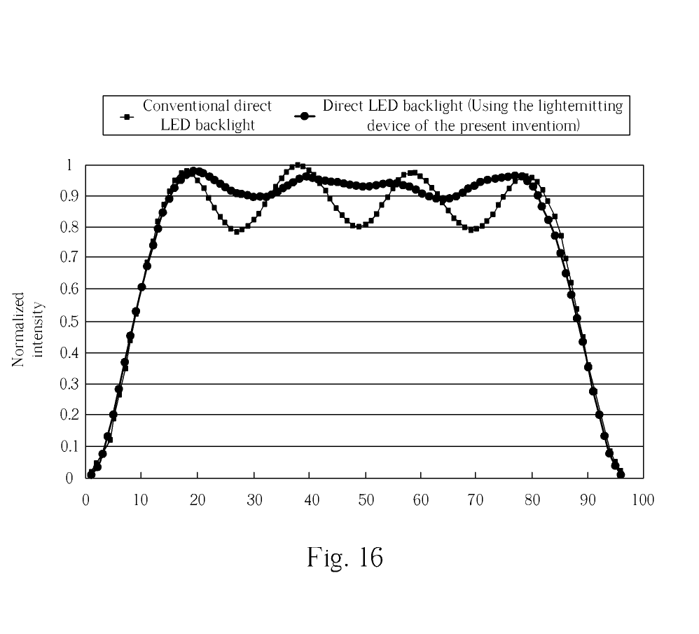

FIG. 16 illustrates a graph showing the distributions of the luminance of light from an LED direct type backlight module 50 using the light-emitting device according to the present invention and from the conventional LED direct type backlight module 10 as shown in FIG. 1. As shown in FIG. 16, the luminance of light is measured along a line transversely over the backlight module and perpendicular to the longitudinal direction of the LED package bars. The abscissa shows the relative position to the left edge of the display. The ordinate shows the normalized intensity of light. The result shows that the light intensity distribution of the backlight module using the light-emitting device of the present invention is more uniform than that of the conventional backlight module.

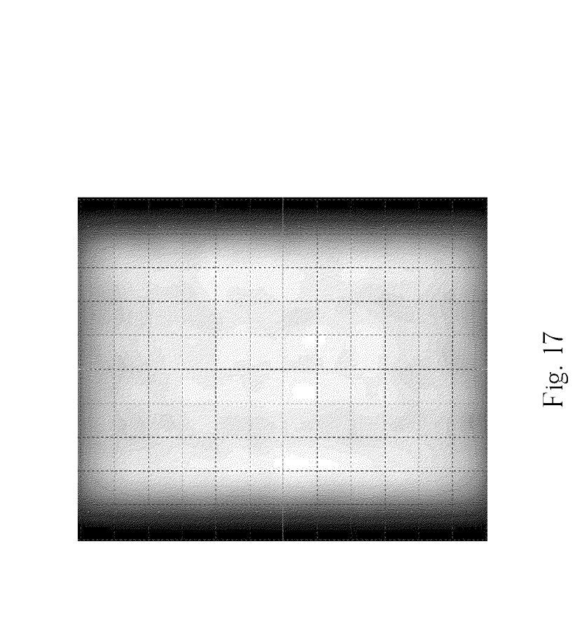

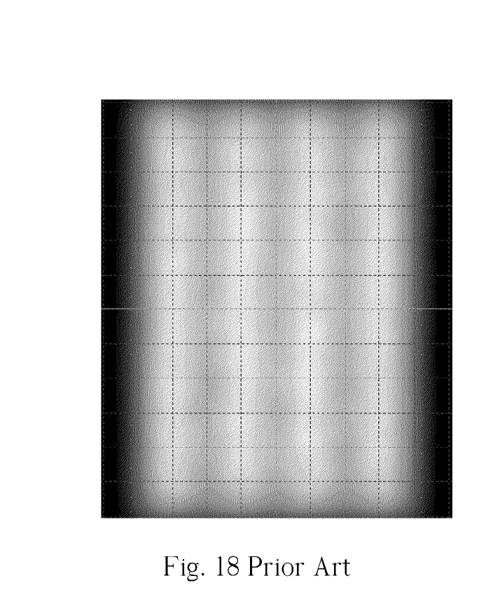

FIGS. 17 and 18 show the display screen for the distributions of the luminance of light from an LED direct type backlight module 50 using the light-emitting device according to the present invention and from the conventional LED direct type backlight module 10, as shown in FIG. 16, respectively. It is shown that the display screen (as shown in FIG. 17) using the light-emitting device of the present invention is more uniform than that (as shown in FIG. 18) of the conventional backlight module.

Accordingly, the light-emitting device of the present invention may be advantageously used in a liquid crystal display which may comprise a liquid crystal display panel and a backlight module for illuminating the liquid crystal display panel, which comprises at least one light source to emit a light and a transparent cap positioned over the light source, wherein the transparent cap has a tapered interior for receiving and refracting the light from the light source and an exterior for refracting the light, and a housing for accommodating the light source, the transparent cap and fixing with the liquid crystal display panel together.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A light-emitting device, comprising:
a light source to emit a light; and
a transparent cap positioned over the light source, wherein the transparent cap has a tapered interior for receiving and refracting the light from the light source and an exterior for refracting the light.

2. The light-emitting device of claim 1, wherein the tapered interior is in a shape selected from a group consisting of conical, ridge, and pyramid.

3. The light-emitting device of claim 2, wherein the shape has an angular tip.

4. The light-emitting device of claim 2, wherein the shape has an arc tip.

5. The light-emitting device of claim 2, wherein the shape has an inclined surface.

6. The light-emitting device of claim 5, wherein the inclined surface has at least one bend.

7. The light-emitting device of claim 1, wherein the exterior comprises a flat top.

8. The light-emitting device of claim 1, wherein the exterior is in an arch shape.

9. The light-emitting device of claim 1, wherein the tapered interior has a tapered angle less than 135 degrees.

10. The light-emitting device of claim 1, wherein the exterior comprises a multi-faceted top.

11. The light-emitting device of claim 10, wherein the multi-faceted top comprises a flat.

12. The light-emitting device of claim 10, wherein the exterior further comprises a side wall inclining inward and downward from the top, such that the light is reflected by the side wall.

13. The light-emitting device of claim 1, wherein the light source is a point light source.

14. The light-emitting device of claim 13, wherein the point light source is a light-emitting diode package.

15. The light-emitting device of claim 1, wherein the transparent cap is formed in a bar shape positioned on a plurality of light sources.

16. The light-emitting device of claim 15, wherein the transparent cap has a plurality of tapered interiors for accommodating the light sources respectively.

17. The light-emitting device of claim 15, wherein the transparent cap has a tapered interior in a ridge shape for accommodating the light sources.

18. The light-emitting device of claim 1, wherein the transparent cap is formed in a plate shape positioned on a plurality of light sources.

19. The light-emitting device of claim 1, wherein the transparent cap comprises a transparent material having a refraction index of 1.3 to 1.8.

20. The light-emitting device of claim 1, wherein the transparent cap is manufactured by diamond turning, injection molding, or casting.

21. A backlight module, comprising:
a base;
a plurality of point light sources positioned on the base; and
a plurality of transparent caps positioned over the point light sources, wherein each transparent cap has a tapered interior accommodating one of the point light sources for receiving and refracting a light from the point light source and an exterior for refracting and emitting the light.

22. The backlight module of claim 21, wherein the transparent caps are integrally formed as a bar.

23. The backlight module of claim 21, wherein the transparent caps are integrally formed as a plate.

24. A liquid crystal display, comprising:
a liquid crystal display panel; and
a backlight module for illuminating the liquid crystal display panel, which comprises at least one light source to emit a light, a transparent cap positioned over the light source, wherein the transparent cap has a tapered interior for receiving and refracting the light from the light source and an exterior for refracting the light, and a housing for accommodating the light source and the transparent cap and fixing with the liquid crystal display panel together.
